(19) United States
(12) Patent Application Publication
(10) Pub. No.: US 2026/0074579 A1
(43) Pub. Date: Mar. 12, 2026

(54) ELECTRIC COMPRESSOR

(71) Applicant: SANDEN CORPORATION, Gunma (JP)

(72) Inventor: Atsuo TESHIMA, Gunma (JP)

(21) Appl. No.: 19/107,277

(22) PCT Filed: Aug. 29, 2023
(86) PCT No.: PCT/JP2023/031299

§ 371 Date: Feb. 27, 2025

(30) Foreign Application Priority Data
Sep. 22, 2022 (JP) 2022-151437

(51) Int. Cl. H02K 5/04; F04C 18/02; H02K 7/14

(52) U.S. Cl. CPC H02K 5/04; F04C 18/0215; H02K 7/14; F04C 2240/30; F04C 2240/40

(57) ABSTRACT

An electric compressor includes a stator housing 7 in a cylindrical shape having one end opened, and a rear casing joined to an opening of the stator housing via a gasket. The stator of an electric motor is housed from the opening of the stator housing, and fixed to an inner surface of the stator housing by shrink fitting. The electric compressor includes a plurality of shrink-fit fixing surfaces 42 which is formed on the inner surface of the stator housing 7 and to which the stator is fixed, a gasket sealing surface 7B which is formed on an opening end surface of the stator housing 7 and on which the gasket is disposed, and a plurality of ribs 49 which is formed on an opening side of an outer surface of the stator housing corresponding to the shrink-fit fixing surfaces.

### TECHNICAL FIELD

The present invention relates to an electric compressor that fixes a stator of a motor in a stator housing by shrink fitting.

### BACKGROUND ART

Heretofore, this type of electric compressor is configured to provide a motor and a compression mechanism driven by the motor in a stator housing. In this case, one end of the stator housing is opened, the motor is provided in the stator housing from the opening, and the opening of the stator housing is closed by joining a rear casing.

In addition, the stator of the motor is fixed to the inner surface of the stator housing by shrink fitting. Therefore, since there is a risk that the gasket sealing surface joining the rear casing is deformed and the sealing performance is deteriorated, in the related art, deformation of the gasket sealing surface is suppressed by forming a large number of ribs on the outer peripheral surface of the stator housing to increase the strength of the stator housing (see, for example, Patent Literature 1.)

### CITATION LIST

### Patent Literature

Patent Literature 1: Japanese Patent 6700674

### SUMMARY OF INVENTION

### Problems to be Solved by Invention

However, when a large number of ribs are formed as in the related art, the weight of the stator housing increases this time, and there is a problem that the cruising distance decreases when the electric compressor is used for, for example, an air conditioner of an electric vehicle.

The present invention has been made to solve the technical problem in the related art, and an object of the present invention is to provide an electric compressor capable of reducing the weight while suppressing deformation of a stator housing to which a stator is fixed by shrink fitting.

### Solution to Problems

An electric compressor according to the present invention includes: a stator housing in a cylindrical shape having one end opened; and a rear casing joined to an opening of the stator housing via a gasket, in which a stator of a motor is housed from the opening of the stator housing and fixed to an inner surface of the stator housing by shrink fitting, the electric compressor including: a plurality of shrink-fit fixing surfaces formed on the inner surface of the stator housing and to which the stator is fixed; a gasket sealing surface formed on an opening end surface of the stator housing and on which the gasket is disposed; and a plurality of ribs formed on an opening side of an outer surface of the stator housing corresponding to the shrink-fit fixing surfaces.

In the invention described above, an electric compressor according to the invention of claim 2 includes a center plate that is accommodated in the stator housing and is located on an opening side of the motor, and a fitting surface to which the center plate is fitted is formed on an inner surface of the stator housing on the opening side of the shrink-fit fixing surface.

In the invention described above, an electric compressor according to the invention of claim 3 is provided with a scroll compression mechanism in a space formed by the center plate and the rear casing.

In the invention described above, an electric compressor according to the invention of claim 4 includes a refrigerant suction port formed at the other end portion of the stator housing, and a refrigerant path formed between the shrink-fit fixing surfaces and communicating the suction port and a refrigerant suction portion of the scroll compression mechanism.

### Effects of Invention

According to the present invention, there is provided an electric compressor including: a stator housing in a cylindrical shape having one end opened; and a rear casing joined to an opening of the stator housing via a gasket, in which a stator of a motor is housed from the opening of the stator housing, and fixed to an inner surface of the stator housing by shrink fitting. When a plurality of shrink-fit fixing surfaces to which the stator is fixed is formed on the inner surface of the stator housing, and a gasket sealing surface on which the gasket is disposed is formed on an opening end surface of the stator housing, a plurality of ribs is formed on an opening side of an outer surface of the stator housing corresponding to the shrink-fit fixing surfaces. Therefore, it is possible to improve strength of the opening side of the stator housing that is most easily deformed during shrink fitting of the stator by the ribs.

As a result, it is possible to suppress an increase in weight of the stator housing due to the formation of the rib while suppressing deformation of the gasket sealing surface with respect to the rear casing, and to reduce the weight of the electric compressor.

Specifically, in the electric compressor including the center plate and the scroll compression mechanism as in claims 2 to 4, it is also possible to suppress the deformation of the center plate fitting surface of the stator housing while reducing the weight, so that the present invention is extremely suitable.

### BRIEF DESCRIPTION OF DRAWINGS

FIG. 1 is a schematic cross-sectional view of an electric compressor according to an embodiment to which the present invention is applied.

FIG. 2 is a perspective view of a stator housing of the electric compressor in FIG. 1.

FIG. 3 is another perspective view of the stator housing of the electric compressor in FIG. 1.

FIG. 4 is a view of the stator housing of the electric compressor in FIG. 1 as viewed from its opening side.

### DESCRIPTION OF EMBODIMENTS

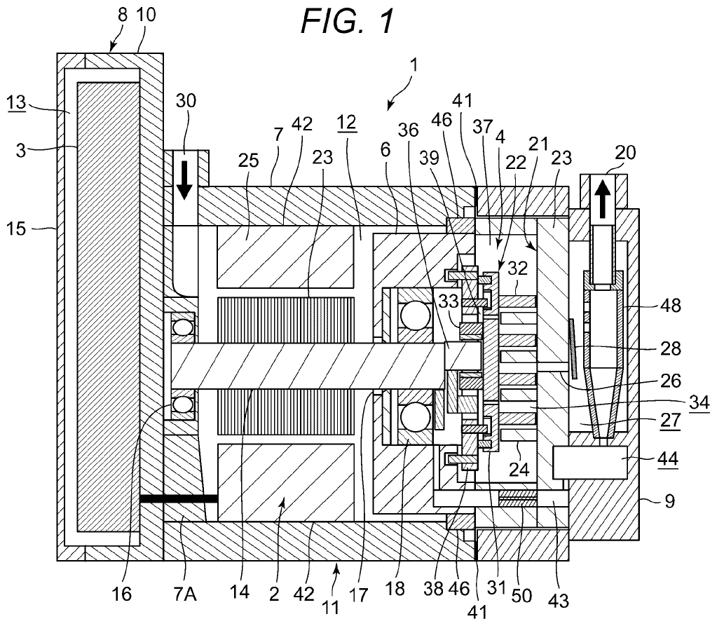

In the following, an embodiment of the present invention will be described in detail with reference to the drawings. FIG. 1 is a schematic cross-sectional view of an electric compressor 1 according to an embodiment to which the present invention is applied.

The electric compressor 1 of the embodiment is used, for example, in a refrigerant circuit of an air conditioner for an electric vehicle, and sucks, compresses, and discharges a refrigerant as a working fluid of the air conditioner to a discharge pipe. The electric compressor I is a so-called horizontal inverter-integrated scroll electric compressor including a three-phase electric motor 2 as a motor in the present invention, an inverter 3 that operates the electric motor 2, and a scroll compression mechanism 4 as a compression mechanism driven by the electric motor 2.

The electric compressor 1 of the embodiment includes a stator housing 7 in a cylindrical shape that accommodates the electric motor 2 and a center plate 6 inside, an inverter case 8 that is attached to an end wall 7A on the other end side of the stator housing 7 and houses the inverter 3 inside, and a rear casing 9 that is attached to the stator housing 7 so as to close an opening on one end side of the stator housing 7.

The stator housing 7, the inverter case 8, and the rear casing 9 are all made of metal (aluminum in the embodiment), and are integrally joined to constitute a housing 11 of the electric compressor 1 of the embodiment.

In the stator housing 7, a motor chamber 12 that accommodates the electric motor 2 is formed. One end of the motor chamber 12 is opened, and the electric motor 2 is accommodated in the motor chamber 12 from the opening, and then the center plate 6 is accommodated from the opening. In addition, the other end surface of the motor chamber 12 is basically closed by the end wall 7A of the stator housing 7. To an inner surface (motor chamber 12 side) of the end wall 7A, a sub-bearing 16 that rotatably supports the other end portion of a drive shaft 14 of the electric motor 2 is attached.

The center plate 6 has an opening on a side (one end side) opposite to the electric motor 2. After a movable scroll 22 of the scroll compression mechanism 4 is accommodated in the opening, the rear casing 9 to which a fixed scroll 21 of the scroll compression mechanism 4 is fixed is fixed to the opening of the stator housing 7 to close the opening. As a result, the scroll compression mechanism 4 is positioned in a space formed by the center plate 6 and the rear casing 9.

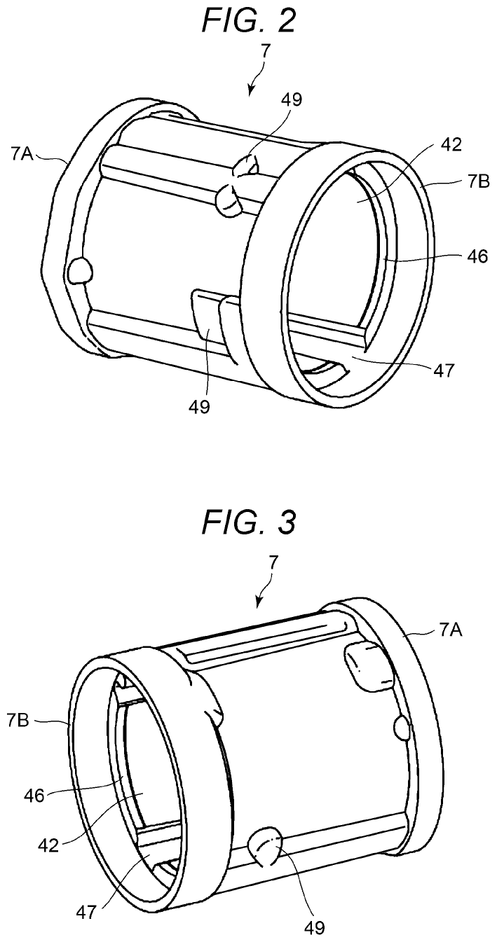

At this time, an opening end surface at one end of the stator housing 7 is a gasket sealing surface 7B (FIG. 2), and an annular gasket 41 that seals a gap between the stator housing 7 and the rear casing 9 is disposed on the gasket sealing surface 7B.

The rear casing 9 is fixed to the opening end surface 7B of the stator housing 7 with a bolt via the gasket 41.

In addition, a through hole 17 through which one end portion of the drive shaft 14 of the electric motor 2 is inserted is opened in the center plate 6, and a main bearing 18 that rotatably supports one end portion of the drive shaft 14 on the scroll compression mechanism 4 side is attached in the center plate 6 on the scroll compression mechanism 4 side of the through hole 17.

The electric motor 2 includes a stator around which a coil is wound and which is fixed to the inner side of the peripheral wall of the stator housing 7 by shrink fitting, and a rotor 23 which rotates inside the stator 25. Then, for example, a direct current from a battery (not shown) of the vehicle is converted into a three-phase alternating current by the inverter 3, and power is supplied to a coil of the stator 25 of the electric motor 2, so that the rotor 23 is rotationally driven. The drive shaft 14 is fixed to the rotor 23.

In addition, a suction port 30 is formed at the other end portion of the stator housing 7, and the refrigerant sucked from the suction port 30 passes through the motor chamber 12 of the stator housing 7, then flows into the center plate 6, and is sucked into a suction portion 37 outside the scroll compression mechanism 4. As a result, the electric motor 2 is cooled by the sucked refrigerant. In addition, the refrigerant compressed by the scroll compression mechanism 4 is discharged from a discharge chamber 27 to a discharge pipe of a refrigerant circuit (not shown) outside the housing 11 through a discharge port 20 formed in the rear casing 9.

The scroll compression mechanism 4 includes the fixed scroll 21 and the movable scroll 22 described above. The fixed scroll 21 integrally includes a disk-shaped end plate 23 and a spiral wrap 24 having an involute shape or a curved shape similar to the involute shape and erected on a surface (one surface) of the end plate 23, and is fixed to the rear casing 9 with the surface of the end plate 23 on which the wrap 24 is erected as the center plate 6 side. In the center of the end plate 23 of the fixed scroll 21, a discharge hole 26 is formed, and the discharge hole 26 communicates with the discharge chamber 27 in the rear casing 9. In the drawing, a reference sign 28 denotes a discharge valve provided at an opening of the discharge hole 26 on a back (the other surface) side of the end plate 23.

The movable scroll 22 is a scroll that revolves relative to the fixed scroll 21, and integrally includes a disk-shaped end plate 31, a wrap 32 erected on a surface (one surface) of the end plate 31, the wrap 32 having an involute shape or a spiral shape formed of a curve closer to the involute shape, and a boss 33 protruding from the center of a back (the other surface) of the end plate 31. The movable scroll 22 is disposed in such a manner that the wrap 32 faces and meshes with the wrap 24 of the fixed scroll 21 with the protruding direction of the wrap 32 facing the fixed scroll 21, and a pressure chamber 34 is formed between the wraps 24 and 32.

That is, the wrap 32 of the movable scroll 22 faces the wrap 24 of the fixed scroll 21, and meshes with the surface of the end plate 23 such that the tip of the wrap 32 is in contact with the surface of the end plate, and the tip of the wrap 24 is in contact with the surface of the end plate 31, and an eccentric portion 36 provided eccentrically from the axis at one end of the drive shaft 14 is fitted to the boss 33 of the movable scroll 22. In addition, it is configured in such a manner that when the drive shaft 14 is rotated together with the rotor 23 of the electric motor 2, the movable scroll 22 performs revolution motion relative to the fixed scroll 21 without rotating on its axis.

Since the movable scroll 22 is eccentric with respect to the fixed scroll 21 and revolves, the wraps 24 and 32 move while rotating in the eccentric direction and the contact position, and the pressure chamber 34 that sucks the refrigerant from the suction portion 37 on the outer side gradually decreases while moving inward. As a result, the refrigerant is compressed and finally discharged from the central discharge hole 26 to the discharge chamber 27 via the discharge valve 28.

In FIG. 1, a reference sign 38 denotes an annular thrust plate. The thrust plate 38 is provided for partitioning a back pressure chamber 39 formed between the back surface of the end plate 31 of the movable scroll 22 and the center plate 6 and the suction portion 37 outside the scroll compression mechanism 4, and is located outside the boss 33 and interposed between the center plate 6 and the movable scroll 22.

In addition, a reference sign 48 denotes a centrifugal oil separator attached in the discharge chamber 27 of the rear casing 9 (the housing 11). The oil separator 48 separates lubricating oil mixed in the refrigerant discharged from the scroll compression mechanism 4 to the discharge chamber 27, and the refrigerant flows toward the discharge port 20 and is discharged to the discharge pipe.

The rear casing 9 is formed with an oil reservoir chamber 44 below the oil separator 48, and the oil separated from the refrigerant by the oil separator 48 flows into the oil reservoir chamber 44 from a lower end of the oil separator 48. In the drawing, a reference sign 43 denotes a back pressure path formed from the rear casing 9 to the center plate 6, and has an orifice 50. The discharge pressure adjusted to reduce the pressure by the orifice 50 of the back pressure path 43 is supplied to the back pressure chamber 39 together with the oil in the oil reservoir chamber 44 separated by the oil separator 48.

The pressure (back pressure) in the back pressure chamber 39 generates a back pressure load that presses the movable scroll 22 against the fixed scroll 21. Under the back pressure load, the movable scroll 22 is pressed against the fixed scroll 21 against a compression reaction force from the pressure chamber 34 of the scroll compression mechanism 4, the contact between the wraps 24 and 32 and the end plates 31 and 23 is maintained, and the refrigerant can be compressed in the pressure chamber 34.

On the other hand, the inverter case 8 includes a case main body 10 constituting an inverter accommodating portion 13 and a lid member 15 closing an opening of the case main body 10. The inverter 3 is accommodated in the inverter accommodating portion 13, and the lid member 15 is attached to the case main body 10 after the inverter 3 is accommodated in the inverter accommodating portion 13.

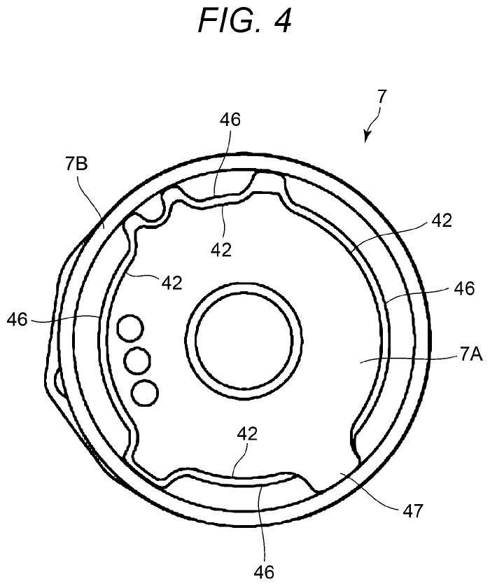

Next, the shape of the stator housing 7 of the electric compressor 1 according to the embodiment will be described with reference to FIGS. 2 to 4. As described above, one end of the stator housing 7 is opened, the opening end surface is the gasket sealing surface 7B, and the other end is closed by the end wall 7A. On the inner surface of the stator housing 7, a plurality of (four in the embodiment) shrink-fit fixing surfaces 42 is formed so as to protrude inward and is spaced from each other, and the respective shrink-fit fixing surfaces 42 abut on the outer surface of the stator 25. The stator 25 is housed in the stator housing 7 from the opening, and then fixed to each shrink-fit fixing surface 42 by shrink fitting.

On the inner surface of the stator housing 7 on the opening side (one end opening side of the stator housing 7) of the shrink-fit fixing surface 42, a plurality of fitting surfaces 46 (center plate fitting surfaces) to which the center plate 6 is fitted is formed to protrude inward, and the center plate 6 is housed in the stator housing 7 from the opening, and then fitted to the fitting surfaces 46 and fixed to the stator housing 7.

In addition, a refrigerant path 47 is formed on the inner surface of the stator housing 7 between the shrink-fit fixing surfaces 42 and the fitting surface 46. The refrigerant path 47 communicates between the suction port 30 and the suction portion 37, and the refrigerant sucked from the suction port 30 is sucked into the scroll compression mechanism 4 from the suction portion 47 through the refrigerant path 47.

Further, on the outer surface of the stator housing 7 corresponding to each shrink-fit fixing surface 42, a plurality of ribs 49 is formed so as to protrude outward (shown in FIGS. 2 and 3, and omitted in FIG. 1.) In this case, each rib 49 is formed only on the opening side of one end of the stator housing 7, and the stator housing 7 is reinforced by the rib 49, and deformation at the time of shrink fitting is suppressed.

With the above configuration, in the electric compressor 1 including the stator housing 7 in a cylindrical shape having one end opened, and the rear casing 9 joined to the opening of the stator housing 7 via the gasket 41, in which the stator 25 of the electric motor 4 is housed from the opening of the stator housing 7, and fixed to the inner surface of the stator housing 7 by shrink fitting, when the plurality of shrink-fit fixing surfaces 42 to which the stator 25 is fixed is formed on the inner surface of the stator housing 7, and the gasket sealing surface 7B on which the gasket 41 is disposed is formed on the opening end surface of the stator housing 7, the plurality of ribs 49 is formed on the opening side of the outer surface of the stator housing 7 corresponding to the shrink-fit fixing surface 42, so that it is possible to improve the strength of the opening side of the stator housing 7 that is most easily deformed at the time of shrink fitting of the stator 25 by the ribs 49.

As a result, while deformation of the gasket sealing surface 7B with respect to the rear casing 9 is suppressed, it is possible to suppress an increase in the weight of the stator housing 7 due to the formation of the rib 49, and to reduce the weight of the electric compressor 1.

Specifically, in the electric compressor 1 including the center plate 6 and the scroll compression mechanism 4 as in the embodiment, it is also possible to suppress deformation of the fitting surface 46 of the stator housing 6 while reducing the weight.

Note that in the embodiment, the scroll electric compressor 1 has been described as an example, but the invention of claim 1 or 2 is not limited to the embodiment, and the present invention is effective for various electric compressors. In addition, the specific shape of each member shown in the examples is not limited to the embodiment, and can be changed without deviating from the gist of the present invention.

### LIST OF REFERENCE SIGNS

1 Electric compressor
2 Electric motor (motor)
3 Inverter
4 Scroll compression mechanism (compression mechanism)
6 Center plate
7 Stator housing
7B Gasket sealing surface
9 Rear casing
11 Housing
12 Motor chamber
13 Inverter accommodating portion
30 Suction port
37 Suction portion
42 Shrink-fit fixing surface
46 Fitting surface (center plate fitting surface)
47 Refrigerant path
49 Rib

1. An electric compressor comprising: a stator housing in a cylindrical shape having one end opened; and a rear casing joined to an opening of the stator housing via a gasket, wherein
a stator of a motor is housed from the opening of the stator housing, and the stator is fixed to an inner surface of the stator housing by shrink fitting,
the electric compressor includes
a plurality of shrink-fit fixing surfaces formed on the inner surface of the stator housing and to which the stator is fixed,
a gasket sealing surface formed on an opening end surface of the stator housing and on which the gasket is disposed, and
a plurality of ribs formed on the opening side of an outer surface of the stator housing corresponding to the shrink-fit fixing surface.

2. The electric compressor according to claim 1, comprising a center plate accommodated in the stator housing and positioned on the opening side of the motor, wherein
a fitting surface to which the center plate is fitted is formed on an inner surface of the stator housing on the opening side of the shrink-fit fixing surface.

3. The electric compressor according to claim 2, wherein a scroll compression mechanism is provided in a space formed by the center plate and the rear casing.

4. The electric compressor according to claim 3, comprising
a suction port formed at the other end portion of the stator housing; and
a refrigerant path formed between the shrink-fit fixing surfaces and communicating the suction port with a suction portion of the scroll compression mechanism.
